(19) United States
(12) Patent Application Publication
(10) Pub. No.: US 2003/0218886 A1
(43) Pub. Date: Nov. 27, 2003

(54) Ornamental lamp for Christmas tree light set

(76) Inventor: Yu-Che Wang, Hsinchu (TW)

Correspondence Address: WANG, Yu-Che, PO Box 82-144, Taipei, TW

(21) Appl. No.: 10/153,814

(22) Filed: May 24, 2002

(51) Int. Cl. F21V 3/04

(52) U.S. Cl. 362/806; 362/363; 362/329; 362/336; 362/339; 362/338; 362/375

(57) ABSTRACT

An ornamental lamp having a colored coarse surface in the periphery of the bulb thereof, the colored coarse surface having a plurality of recessed and protruded ornamental lines extending in different directions and intersecting one another, showing a design.

### BACKGROUND OF THE INVENTION

1. Field of the Invention

The present invention relates to an ornamental lamp and, more particularly, to a new design of glass bulb for an ornamental lamp.

2. Description of the Related Art

Conventional ornamental lamps for Christmas tree light sets have different colors and show different designs. The design of a conventional ornamental lamp is a planar drawing painted or plated on the surface of the glass bulb. When the ornamental lamp turned on, the design of the planar drawing of the ornamental lamp is well seen. However, when light rays of the ornamental lamp passing through the design of the planar drawing, the ornamental lamp does not cause an attractive visual effect.

### SUMMARY OF THE INVENTION

The present invention has been accomplished under the circumstances in view. It is the main object of the present invention to provide an ornamental lamp, which causes an attractive visual effect when turned on. According to the present invention, recessed and/or convex lines of different thickness are formed in the periphery of the glass bulb of the ornamental lamp, showing a design. When the ornamental lamp turned on, the recessed and/or convex lines refract light in different directions, causing an attractive visual effect.

### BRIEF DESCRIPTION OF THE DRAWINGS

FIG. 1 is a perspective view of an ornamental lamp according to the present invention.

FIG. 2 is an enlarged view of part A of FIG. 1.

### DETAILED DESCRIPTION OF THE PREFERRED EMBODIMENT

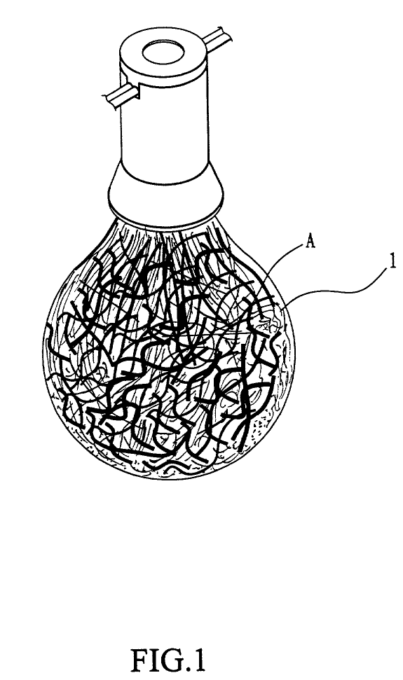

Referring to FIG. 1, an ornamental lamp is shown for use in an ornamental display lamp assembly, for example, a Christmas tree light set, having a glass bulb 1. The glass bulb 1 has a particular color. To provide the desired color, the selected pigment is added to the glass material for making the desired color of glass bulb 1. Alternatively, the glass bulb 1 can be colored with the desired color when made. The glass bulb 1 is processed to provide a coarse surface.

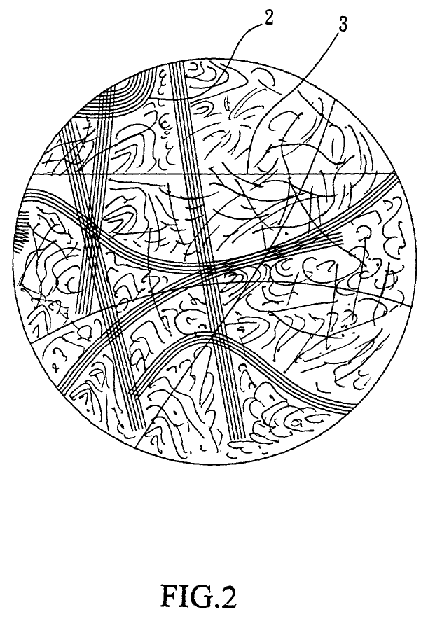

Referring to FIG. 2, the glass bulb 1 has recessed and/or protruded ornamental lines 1 formed in the periphery. The ornamental lines 1 can be straight lines or curved lines of different thickness that extend in different direction and intersect one another, showing a particular design. When the ornamental lamp turned on, the recessed and/or protruded ornamental lines 1 refract light rays in different directions, producing an attractive visual effect.

A prototype of ornamental lamp bulb has been constructed with the features of the annexed drawings of FIGS. 1 and 2. The ornamental lamp bulb functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An ornamental lamp of the type having a colored coarse surface in the periphery of the bulb thereof, wherein said colored coarse surface comprises a plurality of recessed and protruded ornamental lines extending in different directions, showing a design.

2. The ornamental lamp as claimed in claim 1, wherein said recessed and protruded ornamental lines include straight lines and curved lines intersecting one another.
